(19) United States
(12) Patent Application Publication
(10) Pub. No.: US 2025/0045467 A1
(43) Pub. Date: Feb. 6, 2025

(54) MEMORY-SYSTEM RESOURCE PARTITIONING AND MONITORING (MPAM) CONFIGURATION USING SECURE PROCESSOR

(71) Applicant: QUALCOMM Incorporated, San Diego, CA (US)

(72) Inventors: Shashanka HOLLA, Shimoga (IN); Azzedine Adam TOUZNI, Carlsbad, CA (US); Srinivas RAMANA, San Diego, CA (US)

(21) Appl. No.: 18/673,063

(22) Filed: May 23, 2024

(30) Foreign Application Priority Data
Aug. 1, 2023 (IN) 202321051620

(51) Int. Cl. G06F 21/78; G06F 21/60

(52) U.S. Cl. CPC G06F 21/78; G06F 21/606

(57) ABSTRACT

Various embodiments include systems and methods for allocating memory resources in a computing system that includes a Memory-System Resource Partitioning and Monitoring (MPAM) feature. The computing system may transition from using a CPU-controlled MPAM configuration to using an MPAM configuration that is managed by an external entity, such as a CPU co-processor (CPUCP). The computing system may centralize the MPAM operations, introduce various modes of control, and/or incorporate the use of system sensors and parameters to inform autonomous decision-making processes.

### RELATED APPLICATIONS

This application claims priority to India Provisional Patent Application No. 202321051620 entitled “Memory-System Resource Partitioning and Monitoring (MPAM) Configuration Using Secure Processor” filed Aug. 1, 2023, the entire contents of which are incorporated herein by reference for all purposes.

### BACKGROUND

Memory-system resource partitioning and monitoring (MPAM) and system control and management interface (SCMI) are advanced functionalities used in modern computing systems to allow for more efficient and controlled system performance.

The MPAM may be a component that is included in a memory management unit (MMU) of a computing system and configured to partition and monitor system resources (e.g., cache, memory bandwidth, etc.) among different workloads. The computing system may systematically and strategically allocate often limited memory resources. For example, the computing system may intelligently assign specific resources to specific tasks to prevent resource contention and improve the overall system performance. In multiprocessor systems, the computing system may prevent processes from monopolizing shared resources, allowing a more equal distribution of memory access. For these and other reasons, MPAM systems are increasingly used to efficiently manage shared system resources, especially in cloud computing environments and in systems that include multiple cores and/or threads in which multiple applications may execute concurrently and compete for the same memory resources.

SCMI is a standardized interface that facilitates the control and management of system resources in a computing system or computing device. SCMI may allow an operating system (OS) power management software to communicate with the underlying hardware to manage system resources, including power states, performance levels, thermal limits, etc. SCMI may include a set of predefined protocols and messages that the software may use to instruct the hardware on how to adjust its settings. SCMI may be particularly beneficial in systems with complex power and performance requirements in which efficient resource management may lead to significant power savings and improved performance.

MPAM and SCMI technologies are growing in popularity and use. They both allow for the management and control of resources, albeit in slightly different contexts. MPAM may be used for resource partitioning and monitoring, and SCMI may be used as an interface for managing and controlling system-wide resources.

### SUMMARY

Various aspects may include methods of allocating memory resources in a computing system. In some aspects, the method may include centralizing memory-system resource partitioning and monitoring (MPAM) operations, operating the computing system in one of a plurality of control modes (e.g., KERNEL_FULL_CONTROL, HYBRID, SECURE_SW_FULL_CONTROL, etc.), and/or allocating memory segments to software applications represented by different partition identifiers (PARTIDs) that are operating on the computing system or a computing device.

Some aspects may further include dividing the MPAM operations between a request component included in a kernel portion of the computing system and a configure component included in a secure software portion of the computing system. Some aspects may further include using a system control and management interface (SCMI) framework or other inter-processor communications (IPC) mechanism or protocols of the computing to securely communicate information between the request component included in the kernel portion of the computing system and the configure component included in the secure software portion of the computing system.

Some aspects may further include using the SCMI framework or IPC protocol to communicate information between a central processing unit (CPU) core in the computing system and a CPU co-processor (CPUCP) in the computing system.

Some aspects may further include using the SCMI framework or other IPC mechanism or protocol to send an MPAM configuration request message to the configure component included in the secure software portion and operating on the CPUCP.

Some aspects may further include partitioning, by the CPUCP, cache memory for use by multiple software applications operating on the computing system based on specific requirements or priority levels of each of the software applications. In some aspects, partitioning, by the CPUCP, the cache memory for use by multiple software applications operating on the computing system based on the specific requirements or priority levels of each of the software applications may include partitioning, by the CPUCP, the cache memory to reduce cache collisions, cache pollution, or cache thrashing based on MPAM configurations and/or quality of service (QOS) parameters. In some aspects, the QoS parameters may be associated with a component (e.g., L4 cache, DDR, other processing and specialty cores, etc.) that may be configured to support MPAM operations.

In some aspects, partitioning, by the CPUCP, cache memory for use by multiple software applications operating on the computing system based on specific requirements or priority levels of each of the software applications may include partitioning, by the CPUCP, the cache memory so that one cache memory portion may be reserved for secure applications, and the remaining cache memory portions are reserved for non-secure applications.

In some aspects, the kernel assumes complete control over the MPAM configurations for each memory segment or software application and the CPUCP implements the kernel commands without modification while the computing system operates in a KERNEL_FULL_CONTROL mode, the kernel operates as a pass-through component by forwarding received information to the CPUCP and the CPUCP assumes complete control over the MPAM configurations for each memory segment or software application while the computing system operates in a SECURE_SW_FULL_CONTROL mode, the kernel and the CPUCP share control over the MPAM configurations for each memory segment or software application while the computing system operates in a HYBRID mode.

In some aspects, the computing system operates in the HYBRID mode, and the kernel issues commands proposing specific performance configurations, such as a CPU Performance Configuration (CPU_PERF_CONFIG) or a System Performance Configuration (SYSTEM_PERF_CONFIG), and the CPUCP dynamically adjusts the commands to adjust the MPAM configurations based on workload data, real-time system parameters, or additional system information such as data regarding a current resource utilization on the computing system, network traffic, current operations (e.g., data reading, writing, processing tasks, etc.), or hardware-specific data (e.g., thermal sensor readings, the current status of CPU cores, etc.).

In some aspects, the operations for allocating memory segments to software applications represented by different partition identifiers (PARTIDs) that are operating on the computing system may be performed in virtual machines (VM) configured to allow for autonomous or hybrid mode configuration of MPAM.

Some aspects may include a method of allocating memory resources in a computing system that includes receiving, by a CPU co-processor (CPUCP) of the computing system, a kernel request for a memory-system resource partitioning and monitoring (MPAM) configuration in a secure software portion of the computing system and configuring, by the CPUCP, one or more MPAM registers in the computing system based on the received kernel request.

In some aspects, configuring the one or more MPAM registers in the computing system based on the received kernel request may include coordinating, by the CPUCP, the MPAM configurations across multiple security states or between secure and non-secure operations.

Some aspects may further include selecting one of a plurality of operation modes, which may include a KERNEL_FULL_CONTROL mode, a SECURE_SW_FULL_CONTROL mode, and a HYBRID_MODE.

In some aspects, configuring one or more MPAM registers in the computing system based on the received kernel request may include utilizing various system parameters including thermal parameters, core-count parameters, effective frequency parameters, and DDR parameters to allocate cache through MPAM and configure additional Quality of Service (QOS) parameters.

In some aspects, configuring one or more MPAM registers in the computing system based on the received kernel request may include configuring one or more MPAM registers using virtual machines (VMs) and the secure software's autonomous or hybrid mode.

Further aspects may include a computing system or computing device having a processor configured with processor-executable instructions to perform various operations corresponding to the methods summarized above.

Further aspects may include a non-transitory processor-readable storage medium having stored thereon processor-executable instructions configured to cause a processor to perform various operations corresponding to the method operations summarized above.

Further aspects may include a computing system or computing device having various means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIGS. 1-5 are component block diagrams illustrating example components in computing systems that may be configured to implement some embodiments.

FIGS. 6A-6D are process flow diagrams illustrating methods of allocating memory resources in a computing system in accordance with some embodiments.

FIG. 7 is a process flow diagram illustrating a method of allocating memory resources in a computing system that includes virtual machines (VMs) in accordance with some embodiments.

FIGS. 8A-8D are process flow diagrams illustrating methods of allocating memory resources in a computing system using centralizing memory-system resource partitioning and monitoring (MPAM) operations in accordance with some embodiments.

FIG. 9 is a component block diagram illustrating an example computing device suitable for use with various embodiments.

FIG. 10 is a component block diagram illustrating an example wireless communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include systems and methods for allocating memory resources in a computing system that includes a Memory-System Resource Partitioning and Monitoring (MPAM) feature. Various embodiments may include transitioning from using a central processing unit (CPU) controlled MPAM configuration to using an MPAM configuration managed by an external entity, such as a CPU co-processor (CPUCP).

The terms “computing system” and “computing device” may be used herein to refer to any one or all of quantum computing devices, edge devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smartwatch, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processor that can be configured to provide the functionality of various embodiments.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC also may include any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. SoCs also may include software for controlling integrated resources and processors, as well as for controlling peripheral devices.

The term “system in a package” (SIP) may be used herein to refer to a single module or package that contains multiple resources, computational units, cores, or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “Quality of Service (QOS) parameter” may be used herein to refer to parameters that may be used by a computing system to determine how system resources (e.g., cache memory, memory bandwidth, etc.) are to be allocated to different tasks or processes. Some embodiments include computing systems that are configured to use QOS parameters to manage level 3 (L3) cache allocation or other system resources, which may or may not be directly supported by MPAM. For example, in some embodiments, the computing system may be configured to use QOS parameters to manage other cache levels (e.g., L4), the main memory (e.g., double data rate (DDR) memory, etc.), or any of a variety of system processing cores.

Modern computing systems or chipsets (e.g., ARM-based chipsets, etc.) may include, implement, or use a system control and management interface (SCMI) for managing various system functions such as performance, power, and clock management. SCMI may standardize various functions across different hardware platforms to allow the operating system (OS) or other components to control system functions in a platform-agnostic manner. In particular, the SCMI specification outlines an array of standardized extendable interfaces for managing system performance, power, and overall operations. These interfaces may provide access to functions typically embedded within the processor's firmware. As examples, SCMI may include platform interface discovery and self-description interfaces, agent-specific resource isolation interfaces for dynamically modifying an SCMI-compliant agent's access to devices and protocols, power domain management interfaces for managing a device's power-saving states, reset management interfaces for rebooting peripherals or domains, clock management interfaces for handling platform-managed clock rates and sensor management interfaces to monitor sensor data and be notified of changes, and performance management interfaces for controlling the performance of a device, which may include application processors (APs), graphical processing units (GPU), co-processors or accelerators, etc.

Many modern computing systems and chipsets include multi-level caches. A cache may be a small high-speed memory layer that is located closer to the CPU compared to the main memory (RAM). In systems that include multi-level caches, the caches may be organized in a hierarchical manner. Generally, the cache closest to the CPU is the Level 1 (L1) cache, followed by the Level 2 (L2) cache, then the Level 3 (L3) cache, etc. The L1 cache may be the smallest and fastest cache and is often located inside the CPU (each CPU core usually has its own L1 cache). The L2 cache may be larger and slightly slower than the L1 cache, and each CPU core may have its own L2 cache or multiple cores may share an L2 cache. The L3 cache may be larger and slower than the L1 and L2 caches, but still much faster than the main memory. In many modern processors, all CPU cores share the L3 cache.

Modern computing systems or chipsets may include memory subsystems that include various components such as a memory management unit (MMU), cache controller, and memory controller. The MMU may be responsible for translating virtual memory addresses used by the software applications operating on the CPU into physical memory addresses. The MMU may manage the page tables used for these translations, handle page faults, manage memory protection and access rights, ensure that each process in the system has its own isolated secure space in memory, and/or manage the memory hierarchy. The cache controller may be configured to manage the data coming into and going out of the cache memory. For example, an L3 cache controller may manage the operation of the L3 cache.

When a CPU core needs to access data, it may first check the L1 cache, then the L2 cache, and finally the L3 cache, before accessing the main memory. The L3 cache controller may be responsible for determining whether the requested data is in the L3 cache (a cache hit) or not (a cache miss). If it is a cache hit, the cache controller may quickly deliver the data to the CPU. If it is a cache miss, the cache controller may forward the request to the memory controller. The memory controller may interface with the physical memory (e.g., RAM). When it receives a request forwarded from the cache controller (after a cache miss) or directly from the CPU (depending on the architecture), it may translate the request into the appropriate signals for the RAM, read the requested data, and then send it back up to the CPU. If the MMU requests a block of data that is not currently in the cache, the memory controller may fetch the data from RAM and send it to the cache controller, which may update the cache and send the data to the CPU.

In some embodiments, the MMU may be equipped with a MPAM feature/component. MPAM is a feature introduced by Arm Limited that allows software applications to dynamically manage and allocate memory resources to different software applications. As such, MPAM may improve system performance based on the specific needs and priority levels of the software applications. If a software application is more memory-intensive or requires a larger portion of cache memory to operate efficiently, the MPAM may allow a larger cache allocation for this application, thereby improving its performance. On the other hand, if another software application is less memory-intensive or has lower priority, the MPAM may restrict its cache usage, preserving memory resources that can be better utilized by high-priority or memory-intensive applications. These operations may prevent lower-priority or less memory-intensive tasks from hampering the performance and efficiency of more significant tasks. For these and other reasons, MPAM may improve system performance and power consumption characteristics of the computing system, particularly in multi-core and multi-threaded environments in which multiple applications may execute concurrently and thus could potentially vie for the same memory resources.

In conventional MPAM solutions, the CPU is responsible for the control and management of the MPAM operations, which may include assigning partition identifiers (PARTID), configuring cache portions, executing memory transactions, and evaluating cache controllers. Each memory transaction initiated by the CPU may be assigned a unique PARTID that corresponds to a specific application scheduled to run on the CPU. The PARTID may be associated with specific cache configurations that identify the segments of cache memory that may be used by the corresponding software application. For example, an application with a PARTID of 123 may include a configuration that specifies that the application may only use the first 10% of the available cache memory. Another application with a PARTID of 456 may be configured to use the next 20% of the cache memory. Thus, these configurations help guide the MMU to direct the memory transactions to the appropriate cache segments.

The computing system may schedule a software application to run/operate/execute on the CPU and encode the corresponding PARTID so that all memory transactions associated with the software application include the PARTID. The memory transactions may eventually reach an L3 cache controller. In conventional MPAM solutions, the L3 cache controller is an MPAM-compatible controller that is configured to provide the system with the ability to partition the L3 cache differently for various applications or PARTIDs. For example, the L3 cache controller may include settings or configurations that are specific to each PARTID. The cache controller may use the configurations to determine the segment of the cache memory to send the transaction. These and other operations allow the MMU to control and manage the use of cache memory with a higher level of precision and assign different applications to different segments of the cache according to their specific needs and priority levels.

The conventional MPAM solutions described above may include several technical challenges and limitations, such as an inability to allow distributed entities to impact the MPAM configuration, an inability to guarantee system-level Quality of Service (QOS) with the MPAM configuration alone, and inadequate support for coordination between different security states. For example, in conventional MPAM solutions, the MPAM configurations are handled exclusively by the CPU. The memory-mapped registers used for the MPAM configurations are only accessible by the CPU cores. As such, conventional MPAM solutions may limit the ability of entities (e.g., coprocessors, etc.) to adjust the settings or configurations. Said another way, in conventional MPAM solutions, there is no option for a separate system entity to manage and coordinate how different Part IDs (representing applications) impact the system. For these and other reasons, conventional MPAM solutions may be unable to efficiently balance system resources between applications.

In addition, conventional MPAM solutions do not guarantee system-level Quality of Service (QOS) with the MPAM configuration. Generally, QoS may identify a performance level and/or may be used to ensure that specific tasks and applications are allocated the appropriate system resources. By controlling how the cache is allocated and used based on the requirements and priority of each application, the MPAM system may improve QoS for certain applications. However, in conventional MPAM solutions, such QoS improvements may be limited because conventional MPAM solutions often only work with hardware components that are specifically designed to support both ARM and MPAM specifications. This may be a significant limitation because many computing systems include other types of cache memory beyond L3 (e.g., L4 cache, DDR memory, etc.) and/or other components that could include QoS parameters and/or which could be utilized to enhance QoS.

Further, conventional MPAM solutions do not adequately support coordination between different security states (e.g., between secure and non-secure states). Some MPAM solutions support using different MPAM configurations for secure and non-secure applications. However, conventional MPAM solutions often lack coordination components that are suitable for use in ensuring efficient cache usage between the secure and non-secure states. This lack of coordination may result in secure and non-secure applications unintentionally using the same cache portions, which may cause cache thrashing or pollution or otherwise negatively impact the efficiency of the computing system.

Various embodiments include components configured to overcome the above-described limitations of conventional MPAM solutions to improve the performance and functioning of the computing system. The embodiments may allow for transitioning from a CPU-controlled MPAM configuration to one managed by an external entity, such as a CPUCP. The embodiments may centralize the MPAM operations, provide multiple modes of control, and/or incorporate the use of system sensors and parameters to inform autonomous decision-making processes.

Some embodiments may divide the MPAM operations across two components: a request component and a configure component. The request component may be included in or performed by the software application, kernel, or OS. The configure component may be included in or performed by secure software. The computing system may use the SCMI framework or other IPC mechanism or protocol to ensure secure and efficient communication between the request component in the kernel/OS and the configured component in the secure software.

In some embodiments, the computing system may be configured to use the SCMI framework or other IPC mechanism or protocol to facilitate communications between a CPU core and an external entity (e.g., a CPUCP, etc.). For example, the CPU core may send the configurations for a PARTID through the SCMI interface (or other IPC mechanism or protocol) to the co-processor that performs the configuration operations. The co-processor may partition the cache memory for different applications and/or otherwise configure the MPAM and QoS parameters to improve cache usage and/or to reduce the occurrence of cache collisions, cache pollution, cache thrashing, etc.

Generally, software applications operate in either a secure or non-secure state. In the secure state, an application may have access to all system resources and/or may perform any operation. In the non-secure state, the application's operations and access to system resources may be limited or controlled. In some embodiments, the computing system may be configured to allow an external entity (e.g., a CPUCP, etc.) to manage secure and non-secure states. For example, the computing system may be configured to allow the external entity to coordinate between the secure and non-secure states. The external entity may also manage cache portions so that one portion is reserved for secure applications and the remaining portions are used for non-secure applications. These and other operations may prevent cache pollution due to inefficient simultaneous usage of the cache by secure and non-secure applications.

In some embodiments, the computing system may be configured to extend the use of QOS parameters beyond components that support both ARM and MPAM specifications. As discussed above, conventional MPAM solutions may only function with components that support both ARM and MPAM specifications. In some embodiments, the computing system may be configured to allow an external entity to leverage the QoS parameters exposed by other components that ARM or MPAM does not currently support. These embodiments may allow more components to be integrated into the resource management operations, which may result in better resource distribution and improve the performance of the computing system.

In some embodiments, the computing system may be configured to provide access to MPAM configurations. Unlike conventional MPAM solutions in which only the CPU cores access the MPAM configurations, the embodiments may allow the external entity (e.g., a CPUCP, etc.) within the SOC to access the MPAM configurations. For example, the embodiments allow the external entity to coordinate and manage the partitioning of cache resources for different applications represented by different PARTIDs. The external entity may also manage other QoS parameters that are present in the system but which are not MPAM compatible, such as parameters for other caches (e.g., L4, DDR, etc.) or other types of cores in the system. Thus, the external entity may operate as a coordinating entity that may not only manages the partitioning of cache memory for different applications but also handles other system parameters that further enhance the efficiency of the entire transaction path from CPU to memory. As a result, the external entity may improve efficiency throughout the entire transaction path (not just at the level of the L3 cache).

In some embodiments, the computing system may include multiple modes of operation for MPAM configuration, such as KERNEL_FULL_CONTROL, HYBRID, and SECURE_SW_FULL_CONTROL. These operating modes may offer various levels of control to the software application or kernel, ranging from full control by the application/kernel to full control by the secure software. The hybrid mode may balance control between the application/kernel and the secure software. The modes may use a variety of sensors and system parameters (e.g., thermal parameters, core count, effective frequency, DDR frequency, etc.) to intelligently adjust and control the MPAM configurations.

While operating in the KERNEL_FULL_CONTROL mode, the kernel may assume complete control over the MPAM configurations for each segment or application. The external entity may be configured to implement the kernel's commands without any intervention. For example, a request for a particular configuration may be sent from the kernel directly to the external entity (e.g., coprocessor or CPUCP), which may program the MPAM registers precisely as per the kernel's instructions, without any modifications. The external entity may transfer the kernel's configuration data to the MPAM registers and record the information.

While operating in the SECURE_SW_FULL_CONTROL mode, the external entity may assume complete control over the MPAM configuration. The kernel may operate as a pass-through by forwarding the received information to the external entity to configure the MPAM. In this mode, the external entity may override or disregard the kernel's commands.

The HYBRID mode may allow both the external entity and kernel to participate in controlling the configurations to balance control between the kernel and co-processor. In HYBRID mode, the kernel may provide some of the commands or directives to the co-processor (e.g., via a configuration request). The co-processor may modify, adjust, or disregard the commands based on local information and local determinations before programming the MPAM. Examples of local information that could be used by the external entity include application performance requirement information, QOS hints/tunables (system or application-level parameters that may be configured to meet specific performance, reliability, or other QoS goals), current workload information, and cache usage information.

The HYBRID mode may allow the computing system to benefit from using both the kernel application control and the external entity oversight. For example, the kernel may request a specific performance configuration, such as a CPU Performance Configuration (CPU_PERF_CONFIG) or a System Performance Configuration (SYSTEM_PERF_CONFIG), from the external entity. The external entity may use these configurations and metrics to make informed decisions about resource allocation. For example, the external entity may monitor various features, conditions, and real-time system parameters on the device, such as workload demands, operating frequencies, cache usage, etc. Depending on the selected configuration, the external entity may adjust the MPAM settings based on real-time system parameters, ensuring more intelligent and dynamic resource management compared to implementing the kernel requests without modifications. As such, the external entity may dynamically adjust the MPAM configuration to adapt to changing workloads and conditions, which may in turn improve the overall performance of the computing system.

In some embodiments, the external entity may dynamically adjust the MPAM configuration based on workload data. The workload data may include information related to current tasks and processes operating within the system, such as whether a task requires high CPU or memory usage. The external entity may use the workload data to fine-tune the MPAM settings to support the tasks more effectively. For example, the external entity may allocate increased cache space for tasks that demand heavy CPU usage or modify memory partitioning for tasks that are memory intensive.

In some embodiments, the external entity may dynamically adjust the MPAM configuration based on real-time parameters. The real-time parameters may include dynamic elements such as data regarding the system's present resource utilization (e.g., CPU and memory), network traffic, or operations (e.g., data reading, writing, processing tasks, etc.).

In some embodiments, the external entity may dynamically adjust the MPAM configuration based on hardware-specific data, such as thermal sensor readings and the current status of CPU cores (how many are active, idle, etc.). For example, if thermal sensors indicate that the system is overheating, the external entity may adjust the MPAM settings to lower energy usage and heat production. If multiple CPU cores are idle, the external entity may reallocate the resources to improve efficiency.

In some embodiments, the external entity may dynamically adjust the MPAM configuration based on thermal considerations. For example, the external entity may increase the cache allocation for a running task or process in response to determining that the system is running at a very high frequency with high thermal values. Increasing the cache allocation may allow the system to access data faster, reducing the time it takes to complete the task, and thus, allowing the system to cool down sooner.

In some embodiments, the external entity may dynamically adjust the MPAM configuration based on multicore cache management information. For example, the external entity may dynamically adjust cache allocation based on the workloads of the cores in a multi-core system. That is, all cores in a multi-core system may share a common cache (L3), heavy threads (e.g., a thread that requires significant computational resources to execute) may run on the larger high-performance cores (“big cores”), and lighter or smaller threads (e.g., a thread that carries out less computationally intensive tasks compared to heavy threads) may run on smaller more energy-efficient cores (“small cores”). In a gaming scenario in which there are many heavy and light threads operating concurrently in the computing system, the external entity may allocate more of the shared common cache (L3) to the big cores that handle more demanding processes than to the small cores that handle less computationally intensive tasks. These cache management operations may prevent less important tasks from polluting the cache (cache pollution) and reducing the cache space available for heavier or more important tasks. This may in turn allow all the tasks to be completed faster and/or may otherwise improve the overall performance of the computing system.

In some embodiments, the external entity may dynamically adjust the MPAM configuration based on operating frequencies, cache allocation, and/or workloads of the executing tasks in a multi-core system. In some embodiments, the external entity may determine the load on the system based on the real-time operating frequency of one or more cores (effective frequency).

That is, schedulers typically manage the load by distributing tasks among the cores, and Dynamic Voltage and Frequency Scaling (DVFS) may adjust the frequency of the cores based on this load. As such, the external entity may use the effective frequency to adjust cache allocations, increasing cache allocations when the load is heavy and decreasing cache allocations when the load is light. Said another way, the external entity may increase cache allocations in response to determining that the effective frequency is high or greater than a threshold value (which may indicate a higher computational demand or load, etc.). The external entity may decrease cache allocations in response to determining that the effective frequency is low or less than a threshold value, thereby allowing for more efficient usage of the cache memory. Such dynamic adjustment may allow for more efficient use of cache memory and may be particularly beneficial during periods of high computational demand.

In some embodiments, the external entity may dynamically adjust (e.g., based on the load, etc.) the parameters of other components (e.g., CPU, L1, L2, and L3 caches, last-level caches, and DDR controller, etc.) in a memory transaction path beyond the cache controllers, regardless of whether the components support MPAM. As an example, a DDR controller that does not directly support MPAM may expose parameters that may be adjusted to optimize bandwidth. The external entity may adjust the exposed parameters each time it adjusts the L3 cache space allocated to an application or a process running on the computing system. As such, the external entity may dynamically manage the MPAM configuration, operating frequencies, and cache allocation to match the varying workloads of executing tasks in a multi-core system.

In some embodiments, the MPAM operations may be integrated with Virtual Machines (VMs) that allow for autonomous or hybrid mode configuration of MPAM. These embodiments may be especially beneficial in systems in which the VM is not Linux-based or in systems in which each VM operates and makes decisions independent of the activities of other VMs.

In some embodiments, the computing system may include a primary OS and multiple VMs, including a primary VM (PVM), any or all of which may include a variety of different operating systems. In addition, each VM could be running different applications with different memory requirements. For example, one VM could be running a secure camera application, while the PVM may be hosting a variety of applications, including Android-based ones. In this example, the primary VM may not have full visibility of the total system configuration, but it may send its memory requirements to a secondary VM that is tasked with managing the MPAM configuration via the external entity. The secondary VM may receive the MPAM configuration requests from all VMs in the system, compile or aggregate them, and send the aggregated requests to the external entity. The external entity may adjust the MPAM settings based on the aggregated MPAM configuration requests from all VMs in the system.

In some embodiments, the computing system may be configured to request a specific performance bandwidth mode for a specific VM in the system by adjusting system resources (e.g., cache memory allocations, etc.) to increase the data processing capacity allocated to that VM. Performance bandwidth may be a parameter that identifies the data processing capacity or throughput of a system or subsystem. For example, in a multi-core processor, each core may include a certain performance bandwidth in terms of how many instructions it may process per second. The total performance bandwidth of the system could be determined by adding up the individual bandwidths of each core in the system. For virtual machines, performance bandwidth may identify the processing capacity allocated to each VM. For example, a VM with a higher performance bandwidth may be able to process data faster than a VM with a lower performance bandwidth.

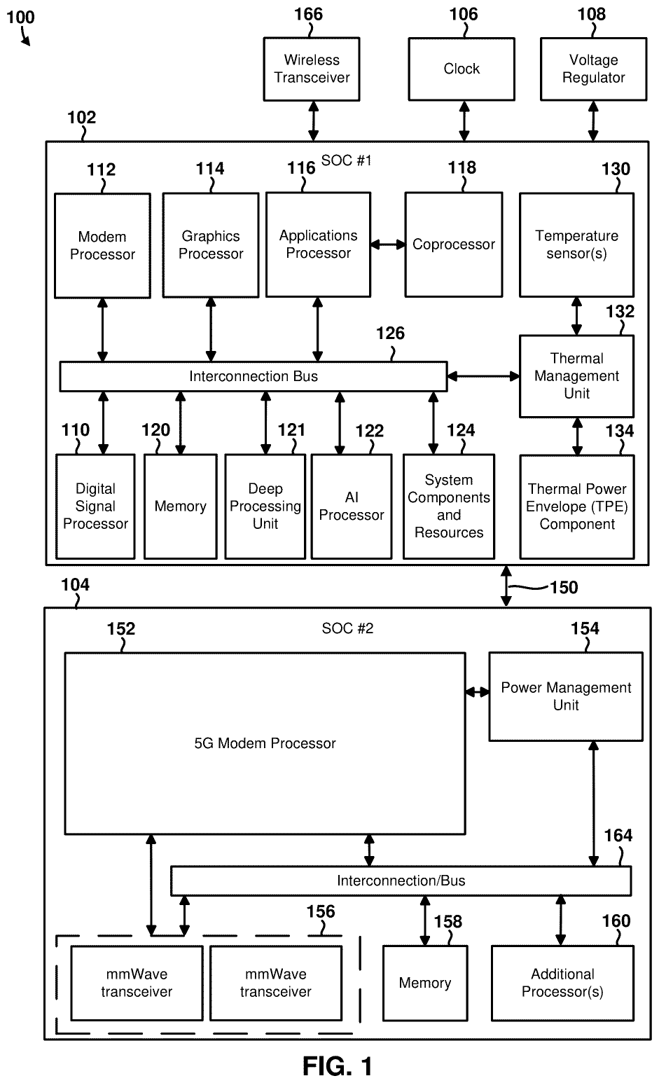

Various embodiments may be implemented on a number of single-processor and multiprocessor computer systems, including a system-on-chip (SOC) or system in a package (SIP). FIG. 1 illustrates an example computing system or SIP 100 architecture that may be used in mobile computing devices implementing various embodiments.

With reference to FIG. 1, the illustrated example SIP 100 includes two SOCs 102, 104, a clock 106, a voltage regulator 108, and a wireless transceiver 166. The first and second SOC 102, 104 may communicate via interconnection bus 150. The various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mm Wave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any or all of the processors 110, 112, 114, 116, 121, 122, in the system may operate as the SoC's main processor, central processing unit (CPU), microprocessor unit (MPU), arithmetic logic unit (ALU), etc. One or more of the coprocessors 118 may operate as the CPUCP.

In some embodiments, the first SOC 102 may operate as the central processing unit (CPU) of the mobile computing device that carries out the instructions of software application programs by performing the arithmetic, logical, control, and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, deep processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a mobile computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as a clock 106, a voltage regulator 108, and a wireless transceiver 166 (e.g., cellular wireless transceiver, Bluetooth transceiver, etc.). Resources external to the SOC (e.g., clock 106, voltage regulator 108, wireless transceiver 166) may be shared by two or more of the internal SOC processors/cores.

In addition to the example SIP 100 discussed above, various embodiments may be implemented in a wide variety of computing systems, which may include a single processor, multiple processors, multicore processors, or any combination thereof.

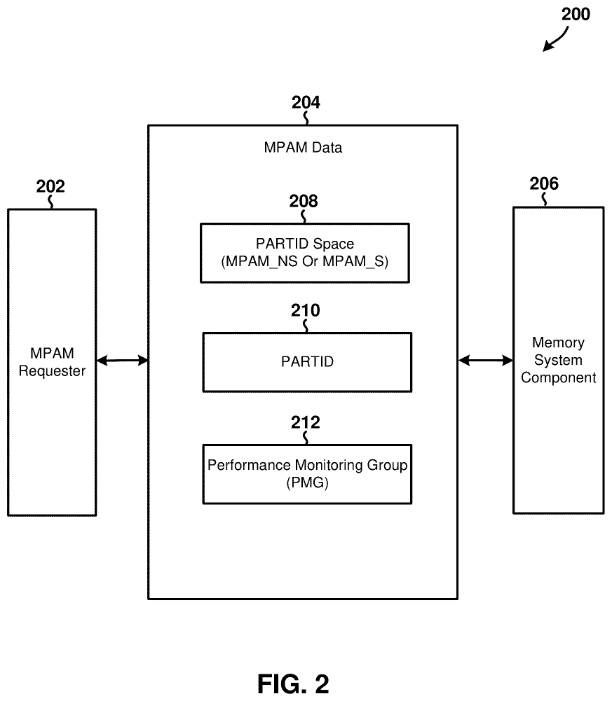

FIG. 2 illustrates example components that could be included in a computing system configured to allocate memory resources in accordance with the embodiments. With reference to FIGS. 1 and 2, a computing system 200 (e.g., SIP 100, SOCs 102, 104, etc.) may include an MPAM requester 202 component, an MPAM data 204 component, and a memory system component 206. The MPAM data 204 component may include a PARTID space 208 component, a PARTID 210 component, and a performance monitoring group 212 component. The PARTID space 208 may indicate whether the MPAM is in a secure space (MPAM_S) or in a non-secure space (MPAM_NS).

The various components 202-212 may interact to manage and allocate memory resources in the computing system. The MPAM requester 202 component may be configured to generate or manage MPAM requests, which may include determining how memory resources should be allocated or deallocated based on factors such as workload demands or system performance.

The MPAM data 204 component may be configured to store data related to the memory partitioning and monitoring operations. The PARTID space 208 component may indicate whether the MPAM operations are to be performed in a secure space (MPAM_S) or a non-secure space (MPAM_NS). Each memory transaction within the system is assigned a unique PARTID 210. This identifier may be linked to a specific software application running on the system and/or associated with a cache configuration that defines the segments of cache memory that the corresponding software application may use. The Performance Management Group (PMG) 212 component may be configured to monitor and track system performance. For example, the PMG 212 may provide insights into the efficiency of the memory allocations and or help inform decisions about how to adjust the cache memory allocations to improve performance.

The memory system component 206 may be configured to manage the physical memory resources. The memory system component 206 may receive a memory transaction with a specific PARTID, determine the appropriate segment of the L3 cache memory based on the PARTID, and send the transaction to the appropriate segment of the L3 cache memory. The memory system component 206 may include an L3 cache controller configured to partition the L3 cache differently for each PARTID and allocate memory resources according to the specific needs of each application running on the system.

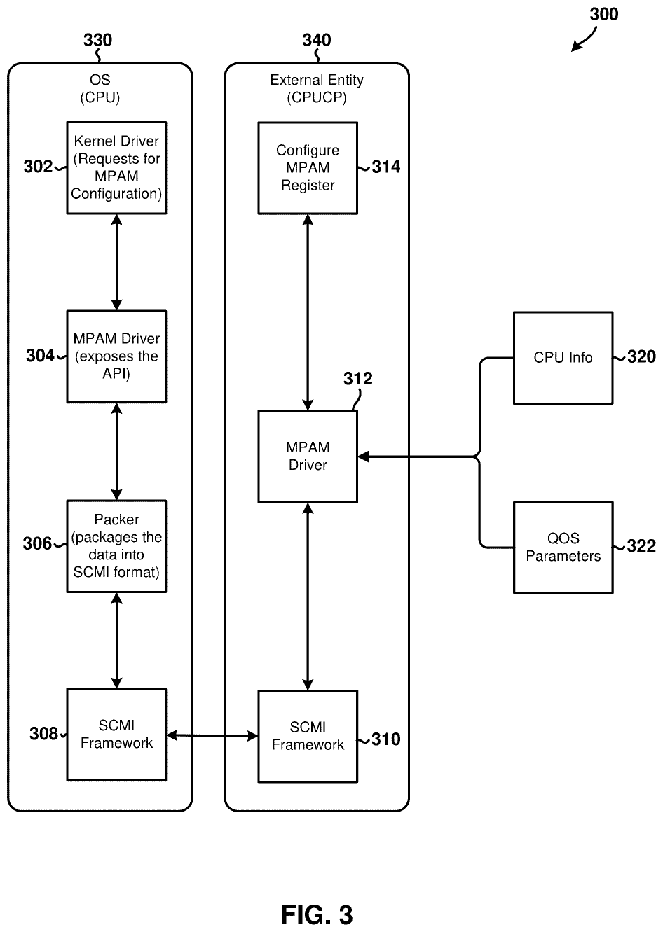

FIG. 3 illustrates additional components that could be included in a computing system configured to allocate memory resources in accordance with the embodiments. With reference to FIGS. 1-3, a computing system 300 (e.g., SIP 100, SOCs 102, 104, computing system 200, etc.) may include an OS 330 component, a external entity 340 component, a CPU info 320 component, and a QOS parameters 322 component. The OS 330 component includes a Kernel Driver 302 component, an MPAM Driver 304 component, a packer 306 component, and an SCMI Framework 308 component. The external entity 340 component may include a SCMI Framework 310 component, an MPAM driver 312 component, and a Configure MPAM register 314 component.

As mentioned above, some embodiments may divide the MPAM operations across two components: a request component and a configure component. In some embodiments, the Kernel Driver 302 component may be the request component that is included in or performed by the software application, kernel, or OS 330. In some embodiments, the Configure MPAM register 314 may be the configure component that is included in or performed by secure software.

The OS 330 component may operate on the main CPU of the system. The OS 330 component may be configured to manage the applications running on the system and interact with the hardware. The Kernel Driver 302 may generate MPAM configuration requests for the allocation or reallocation of memory resources. The MPAM Driver 304 may include application programming interfaces (APIs) that allow software applications to interact with the MPAM system. The packer 306 may prepare and package the data into an appropriate SCMI format. The SCMI Framework 308 may facilitate secure and efficient communication between the Kernel Driver 302 in the kernel/OS and the configure component 314 in the secure software.

The external entity 340 component may include secure software that operates on the CPUCP (e.g., coprocessor 118, etc.). In some embodiments, the external entity may be the CPUCP or coprocessor 118. The external entity may be configured to manage CPU resources and assist in configuring the MPAM. The external entity may manage the partitioning of cache memory between different applications, represented by different PARTIDs to improve resource usage and reduce cache collisions, cache pollution, and cache thrashing. The external entity may manage the transitions between secure and non-secure states and the simultaneous use of cache resources by software applications operating in the secure and/or non-secure states. The external entity may reduce cache pollution caused by inefficient simultaneous usage by secure and non-secure applications.

The SCMI Framework 310 may mirror its counterpart in the OS 330 to ensure secure communication between the CPU and the CPUCP. The MPAM driver 312 may be configured to allow the CPUCP to control the MPAM from secure software. The configure MPAM register 314 component may be configured to directly modify the MPAM settings based on requests from the Kernel Driver 302.

The CPU info 320 component may store data related to the state and performance of the CPU, such as current usage of CPU resources, performance metrics, and more.

The QOS parameters 322 component may store QoS parameters that may be used to determine the allocation of resources and ensure that all processes meet their performance requirements. The external entity may use QoS parameters for components that support both ARM and MPAM specifications, and for components that do not support the ARM or MPAM specifications.

The computing system 300 may provide the external entity access to the MPAM configurations, which would otherwise be only accessible to CPU cores. The computing system 300 may provide the external entity authority to manage the partitioning of cache resources for different applications represented by different PARTIDs and handle other system parameters enhancing the efficiency of the entire transaction path from the CPU to memory. The computing system 300 may enhance efficiency throughout the entire transaction path (not just at the level of the L3 cache).

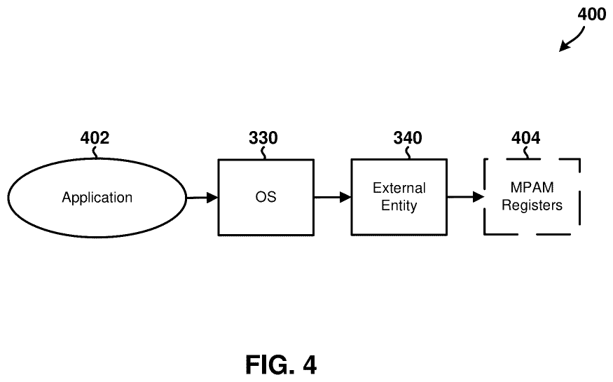

FIG. 4 illustrates an example transaction path that could be traversed by a computing system configured in accordance with the various embodiments when operating in KERNEL_FULL_CONTROL mode. With reference to FIGS. 1-4, a computing system 400 (e.g., SIP 100, SOCs 102, 104, computing system 200, 300, etc.) may include an application 402 component, an OS 330 component, an external entity 340 component, and an MPAM registers 404.

In the KERNEL_FULL_CONTROL mode, the kernel in the OS 330 component controls the MPAM configurations, which the external entity 340 component implements by programming the MPAM Registers 404 as per the kernel's instructions without any alterations.

The application 402 component may include the software applications running on the computing system. Examples of software applications include user-interface applications (e.g., web browsers, text editors, etc.) and background applications (e.g., servers, system monitors, etc.).

The OS 330 component may include the kernel, which has total control over MPAM configurations for each segment or application during KERNEL_FULL_CONTROL mode. The kernel may make all decisions regarding how the system's memory resources are allocated among the different software applications running on the system.

The external entity 340 component (CPUCP) may be configured to implement the kernel's commands without any intervention. The external entity 340 component may receive a request for a particular configuration from the kernel or application, and program the MPAM registers exactly according to the kernel's instructions (without any modifications).

The MPAM registers 404 may store the MPAM configurations for how memory resources are allocated among the software applications. The external entity 340 may receive configuration data from the kernel and store it in the MPAM registers 404.

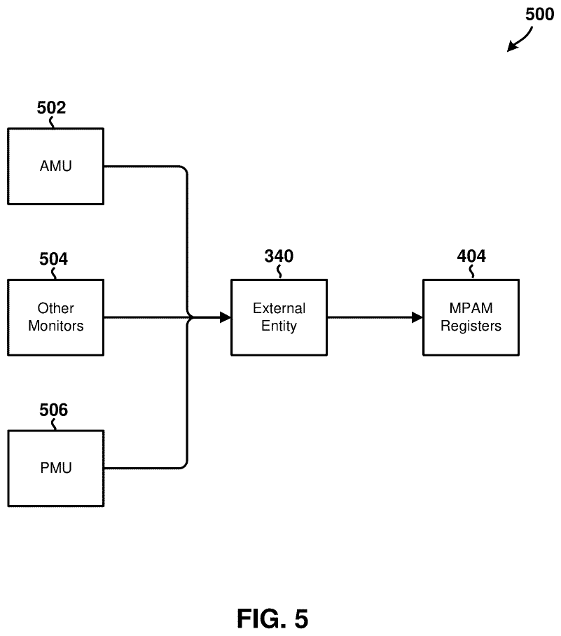

FIG. 5 illustrates example components in a computing system that could be configured in accordance with the various embodiments. With reference to FIGS. 1-5, a computing system 500 (e.g., SIP 100, SOCs 102, 104, computing system 200, 300, 400, etc.) may include an activity monitoring unit (AMU) 502, other monitors 504, a performance monitoring unit (PMU) 506, external entity 340, and MPAM registers 404.

In the SECURE_SW_FULL_CONTROL mode, the decision-making power is given to the external entity 340 (e.g., CPUCP) which may determine the MPAM configuration based on input from the AMU 502, PMU 506, and other monitors 504. As such, the computing system 500 may dynamically adapt to changes in workload, temperature, power usage, and other factors to improve the performance and efficiency of the computing system.

The AMU 502 may monitor CPU activity to allow software applications to make better-informed power management decisions. The AMU 502 may measure and report the utilization of computing resources, such as pipeline depth or rename register utilization, which may be used to determine or characterize the CPU behavior and identify performance bottlenecks.

The other monitors 504 may include any of a variety of monitoring systems or components within the computer system, such as thermal monitors (which monitor CPU and system temperature), power monitors (which monitor power consumption), and system event monitors (which monitor system events like interrupts, faults, or other significant occurrences).

The PMU 506 may be a component of the CPU that is configured to provide metrics and data related to the performance of the processor. The metrics and data may include measurements of clock cycles, cache hits and misses, instruction counts, and other low-level data, any or all of which may be used to determine or characterize the processor behavior and identify performance bottlenecks.

In the SECURE_SW_FULL_CONTROL mode, the external entity 340 may assume complete control over the MPAM configuration. The external entity 340 may make decisions about how to configure the MPAM based on the data it receives from the AMU 502, PMU 506, and other monitors 504. The kernel in this mode may operate as a pass-through, forwarding the information it receives to the external entity 340, which may override or ignore the commands from the kernel while operating in this mode.

The MPAM registers 404 may store the MPAM configurations for how memory resources are allocated among the software applications. The external entity 340 may make MPAM configuration decisions and store them in the MPAM registers 404. The MPAM may then use the configurations stored in these registers to control how different parts of the cache are allocated or used.

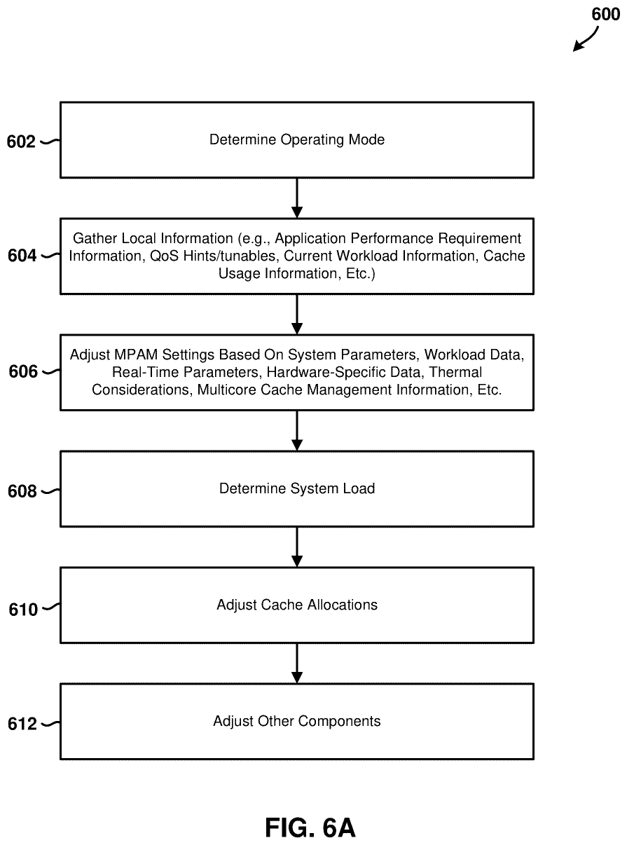

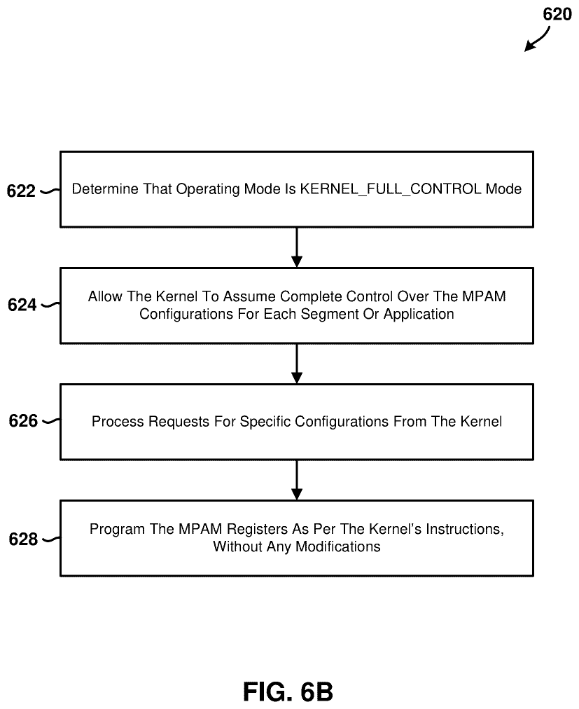

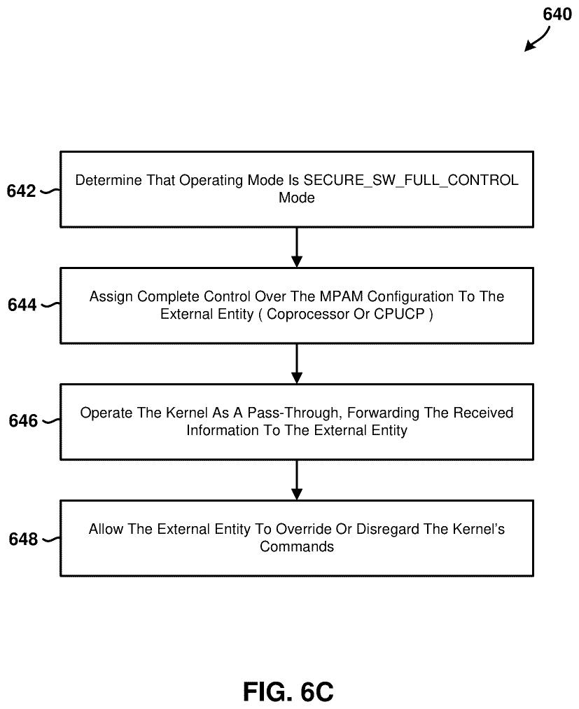

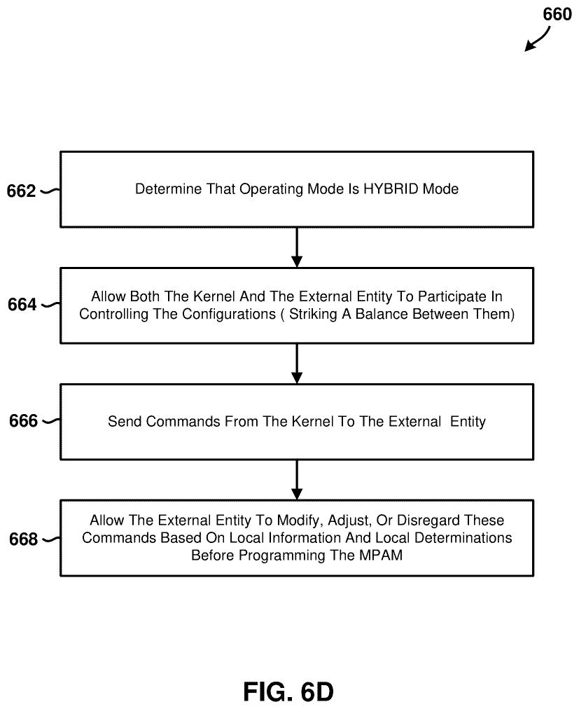

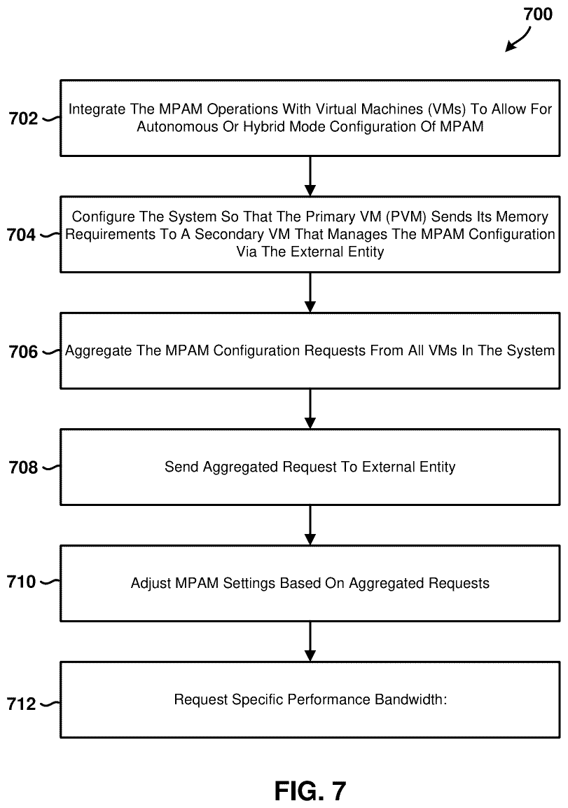

FIGS. 6A-6D and 7 are process flow diagrams illustrating methods 600, 620, 640, 660, 700 of allocating memory resources in a computing system in accordance with some embodiments. The operations in FIGS. 6A-6D and 7 may be performed in a computing system by any or all of the processing units (e.g., processors 110, 112, 114, 116, 118, 121, 122, 121, 122, 152, 160, etc.), components, or subsystems discussed in this application. Means for performing the functions of the operations in FIGS. 6A-6D and 7 may include any or all of the processing units (e.g., processors 110, 112, 114, 116, 118, 121, 122, 121, 122, 152, 160, etc.), components, or subsystems discussed in this application.

With reference to FIGS. 1-6A, in block 602 of the method 600, the processing system may determine the current mode of operation for MPAM configuration. The computing system may include multiple modes of operation for MPAM configuration, such as KERNEL_FULL_CONTROL, HYBRID, and SECURE_SW_FULL_CONTROL. These operating modes may offer various levels of control to the software application or kernel, ranging from full control by the application/kernel to full control by the secure software. The hybrid mode may balance control between the application/kernel and the secure software. The modes may use a variety of sensors and system parameters (e.g., thermal parameters, core count, effective frequency, DDR frequency, etc.) to intelligently adjust and control the MPAM configurations.

In some embodiments, the determined operating mode (e.g., determined in block 602 above) may influence how the kernel and/or CPUCP interact with the MPAM configurations. Said another way, in some embodiments, the selection of the operating mode may directly influence the allocation of resources across different PARTIDs. Each operating mode may cause the processing units in the computing system to apply a different strategy for the allocation of resources that focuses on prioritizing a different balance between performance, security, and efficiency. For example, in the KERNEL_FULL_CONTROL mode, the kernel may be responsible for allocating memory segments to software applications and may cause the processing unit to do so based on performance (e.g., by prioritizing high-demand applications or those requiring immediate resource access, etc.). In the SECURE_SW_FULL_CONTROL mode, an external entity (e.g., secure software, etc.) may be responsible for allocating the memory segments to the software applications and may cause the processing unit to do so based on security (e.g., by prioritizing secure, trusted, or low-risk applications, etc.). In the HYBRID mode, multiple controlling entities (e.g., the kernel and secure software) may allocate the memory segments to the software applications. For example, in HYBRID mode, the kernel may cause the processing unit to allocate memory based on performance needs while allowing the external entity or secure software to cause the processing unit to adjust the memory allocations to comply with security policies.

In block 604, the processing system may gather local information, such as application performance requirement information, QoS hints/tunables, current workload information, cache usage information, etc. For example, in the HYBRID mode the co-processor may modify, adjust, or disregard the commands based on local information and local determinations before programming the MPAM. Examples of local information include application performance requirement information, QoS hints/tunables (system or application-level parameters that may be configured to meet specific performance, reliability, or other QoS goals), current workload information, and cache usage information.

In block 606, the processing system may adjust MPAM settings based on system parameters, workload data, real-time parameters, hardware-specific data, thermal considerations, multicore cache management information, etc. In some embodiments, the processing system may adjust the MPAM settings based on the gathered local information. In some embodiments, the processing system may dynamically adjust the MPAM configuration based on workload data. The workload data may include information related to current tasks and processes operating within the system. In some embodiments, the processing system may dynamically adjust the MPAM configuration based on real-time parameters. The real-time parameters may include dynamic elements such as data regarding the system's present resource utilization, network traffic, or operations. In some embodiments, the processing system may dynamically adjust the MPAM configuration based on hardware-specific data, such as thermal sensor readings and the current status of CPU cores. In some embodiments, the processing system may dynamically adjust the MPAM configuration based on thermal considerations. In some embodiments, the processing system may dynamically adjust the MPAM configuration based on multicore cache management information.

In block 608, the processing system may determine the system load. For example, in some embodiments, the external entity may determine the load on the system based on the real-time operating frequency of one or more cores (effective frequency). That is, schedulers typically manage the load by distributing tasks among the cores, and Dynamic Voltage and Frequency Scaling (DVFS) may adjust the frequency of the cores based on this load. As such, the external entity may use the effective frequency to adjust cache allocations, increasing cache allocations when the load is heavy and decreasing cache allocations when the load is light. Said another way, the external entity may increase cache allocations in response to determining that the effective frequency is high or greater than a threshold value (which may indicate a higher computational demand or load, etc.). The external entity may decrease cache allocations in response to determining that the effective frequency is low or less than a threshold value, thereby allowing for more efficient usage of the cache memory. Such dynamic adjustment may allow for more efficient use of cache memory and may be particularly beneficial during periods of high computational demand.

In block 610, the processing system may adjust cache allocations. For example, the processing system may use the effective frequency to adjust cache allocations, increasing cache allocations when the load is heavy and decreasing cache allocations when the load is light. For example, if a software application is more memory-intensive or requires a larger portion of cache memory to operate efficiently, the processing system may allow a larger cache allocation for this application, thereby improving its performance. On the other hand, if another software application is less memory-intensive or has lower priority, the processing system may restrict its cache usage, preserving memory resources that can be better utilized by high-priority or memory-intensive applications.

In block 612, the processing system may adjust other components. For example, the processing system may dynamically adjust (e.g., based on the load, etc.) the parameters of other components (e.g., CPU, L1, L2, and L3 caches, last-level caches, and DDR controller, etc.) in a memory transaction path beyond the cache controllers, regardless of whether the components support MPAM. As an example, a DDR controller that does not directly support MPAM may expose parameters that may be adjusted to optimize bandwidth. The external entity may adjust the exposed parameters each time it adjusts the L3 cache space allocated to an application or a process running on the computing system. As such, the external entity may dynamically manage the MPAM configuration, operating frequencies, and cache allocation to match the varying workloads of executing tasks in a multi-core system.

With reference to FIGS. 1-6B, in block 622 of the method 620, the processing system may determine that the current mode of operation for MPAM configuration is KERNEL_FULL_CONTROL.

In block 624, the processing system may allow the kernel to assume complete control over the MPAM configurations for each segment or application. That is while operating in the KERNEL_FULL_CONTROL mode, the kernel may assume complete control over the MPAM configurations for each segment or application. The external entity may be configured to implement the kernel's commands without any intervention. For example, a request for a particular configuration may be sent from the kernel directly to the external entity (e.g., coprocessor or CPUCP), which may program the MPAM registers precisely as per the kernel's instructions, without any modifications. The external entity may transfer the kernel's configuration data to the MPAM registers and record the information. As such, in block 626, the processing system may process requests for specific configurations from the kernel. In block 628, the processing system may program the MPAM registers as per the kernel's instructions, without any modifications.

With reference to FIGS. 1-6C, in block 642 of the method 640, the processing system may determine that the current mode of operation for MPAM configuration is SECURE_SW_FULL_CONTROL. In block 644, the processing system may assign complete control over the MPAM configuration to the external entity (coprocessor 118 or CPUCP). That is while operating in the SECURE_SW_FULL_CONTROL mode, the external entity may assume complete control over the MPAM configuration. The kernel may operate as a pass-through by forwarding the received information to the external entity to configure the MPAM. In this mode, the external entity may override or disregard the kernel's commands. Accordingly, in block 646, the processing system may operate the kernel as a pass-through by forwarding the received information to the external entity. In block 648, the processing system may allow the external entity to override or disregard the kernel's commands.

With reference to FIGS. 1-6D, in block 662 of the method 660, the processing system may determine that the current mode of operation for MPAM configuration is the HYBRID mode. In block 664, the processing system may allow both the kernel and the external entity to participate in controlling the configurations (striking a balance between them). That is, the HYBRID mode may allow both the external entity and kernel to participate in controlling the configurations to balance control between the kernel and co-processor. In HYBRID mode, the kernel may provide some of the commands or directives to the co-processor (e.g., via a configuration request). The co-processor may modify, adjust, or disregard the commands based on local information and local determinations before programming the MPAM. Examples of local information that could be used by the external entity include application performance requirement information, QoS hints/tunables (system or application-level parameters that may be configured to meet specific performance, reliability, or other QoS goals), current workload information, and cache usage information.

In block 666, the processing system may send commands from the kernel to the external entity.

In block 668, the processing system may allow the external entity to modify, adjust, or disregard these commands based on local information and local determinations before programming the MPAM.

With reference to FIGS. 1-7, in block 702 of the method 700, the processing system may integrate the MPAM operations with Virtual Machines (VMs) to allow for autonomous or hybrid mode configuration of MPAM. In some embodiments, the VMs may operate independently of each other.

In block 704, the processing system may configure the system so that the primary VM (PVM) sends its memory requirements to a secondary VM that manages the MPAM configuration via the external entity. In some embodiments, the system may include a primary OS and multiple VMs, including a primary VM (PVM), each running different applications with different memory requirements.

In block 706, the processing system may aggregate the MPAM configuration requests from all VMs in the system.

In block 708, the processing system may send the aggregated request to the external entity.

In block 710, the processing system may adjust MPAM settings based on aggregated requests.

In block 712, the processing system may request a specific performance bandwidth. For example, the system may configure the computing system to request a specific performance bandwidth mode for a specific VM in the system by adjusting system resources to increase the data processing capacity allocated to that VM. As discussed above, performance bandwidth may be a parameter that identifies the data processing capacity or throughput of a system or subsystem. For example, in a multi-core processor, each core may include a certain performance bandwidth in terms of how many instructions it may process per second. The total performance bandwidth of the system could be determined by adding up the individual bandwidths of each core in the system. For virtual machines, performance bandwidth may identify the processing capacity allocated to each VM. For example, a VM with a higher performance bandwidth may be able to process data faster than a VM with a lower performance bandwidth.

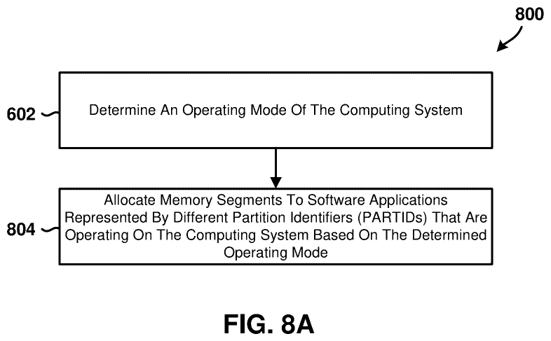

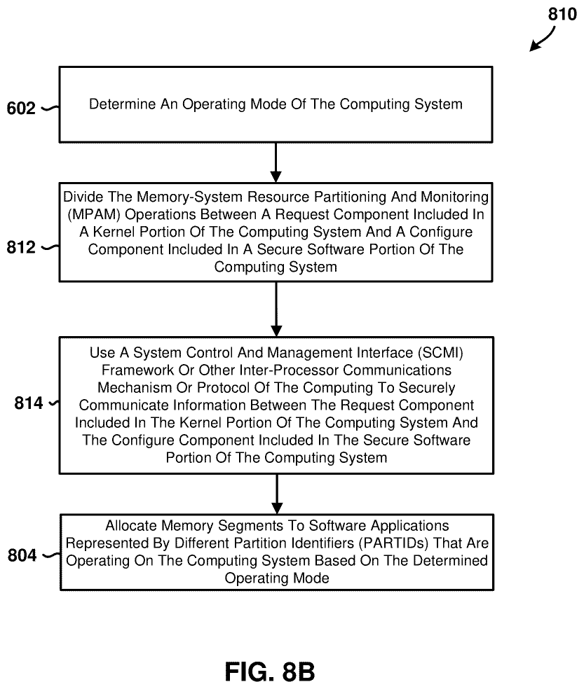

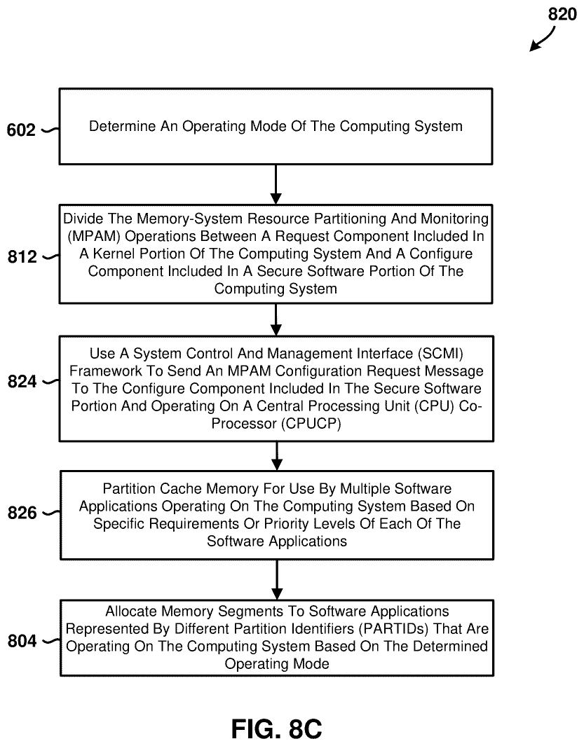

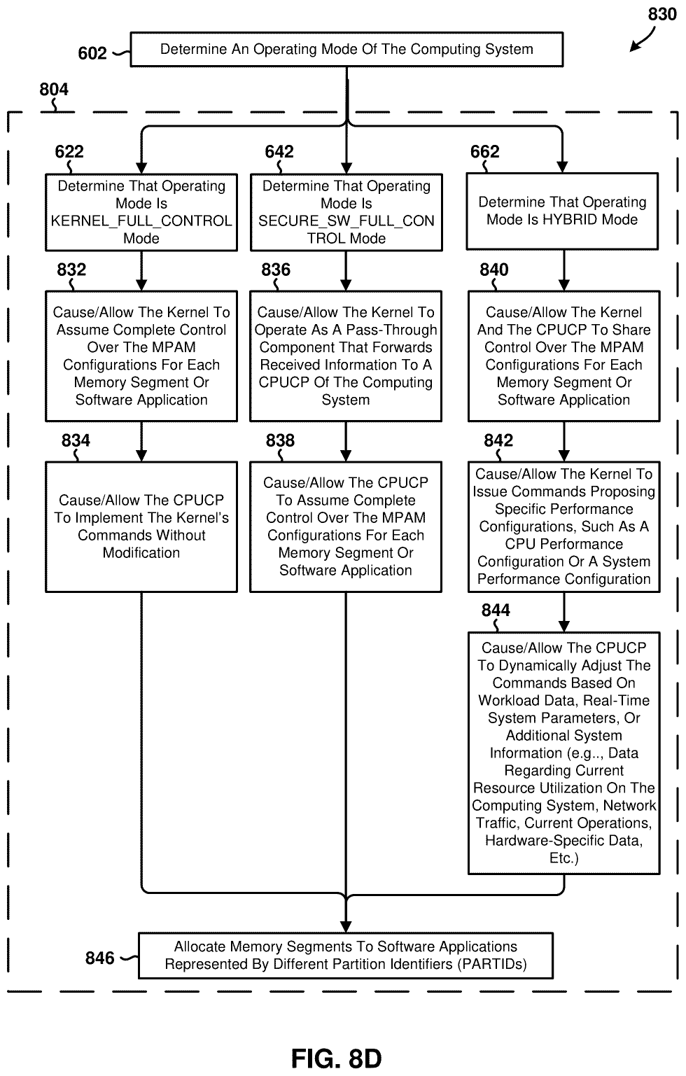

FIGS. 8A-8D are process flow diagrams illustrating methods 800, 810, 820, 830 of allocating memory resources in a computing system in accordance with some embodiments. The operations in FIGS. 8A-8D may be performed in a computing system by any or all of the processing units (e.g., processors 110, 112, 114, 116, 118, 121, 122, 121, 122, 152, 160, etc.), components, or subsystems discussed in this application. Means for performing the functions of the operations in FIGS. 8A-8D may include any or all of the processing units (e.g., processors 110, 112, 114, 116, 118, 121, 122, 121, 122, 152, 160, etc.), components, or subsystems discussed in this application.

For the sake of clarity and ease of presentation, methods 600, 620, 640, 660, 700, 800, 810, 820, 830, are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. to produce a modified or alternative result or solution. The presentation of individual methods, blocks, operations, etc. should not be interpreted as mutually exclusive, limiting, or as being required unless expressly recited as such in the claims.

With reference to FIGS. 1-8A, in block 602 of method 800 (FIG. 8A), as well as methods 810, 820, 830, the processing system may perform the operations of the like-numbered block of method 600 as described. For example, the processing system may actively determine the current mode of operation for MPAM configuration, which in turn, may set the foundational strategy for how resources will be managed and allocated across the system. In some embodiments, determining the operating mode may include analyzing current system conditions, workload demands, and security requirements. In some embodiments, determining the operating mode may further include analyzing any of a variety of sensors and system parameters such as thermal conditions, core count, effective frequency, and DDR frequency to make an informed decision about the most suitable operating mode. In some embodiments, the processing system may use the analysis results to select between KERNEL_FULL_CONTROL, SECURE_SW_FULL_CONTROL, and HYBRID modes. In some embodiments, the selection or determination of the operating mode in block 602 may directly influence subsequent actions and the overall approach to resource allocation on the computing system.

In block 804, the processing system may allocate memory segments to software applications represented by different PARTIDs that are operating on the computing system based on the determined operating mode. For example, in KERNEL_FULL_CONTROL mode, the processing system may allocate memory segments to software applications to prioritize applications requiring high bandwidth or processing speed. The processing system may also dynamically adjust the resource distribution based on real-time performance metrics. As another example, in SECURE_SW_FULL_CONTROL mode, the processing system may allocate memory segments to software applications to prioritize applications that handle sensitive data with secure memory segments. In HYBRID mode, the processing system may allocate memory segments to software applications by merging the performance and security strategies and/or causing or allowing both the kernel and secure software to collaboratively decide on resource allocation.

With reference to FIGS. 1-8B, in block 602 of method 810 (FIG. 8B), the processing system may perform the operations of the like-numbered blocks of methods 600 and 800 as described.

In block 812, the processing system may divide the MPAM operations between a request component in the kernel and a configure component in the secure software. In some embodiments, in block 812, the processing system may perform the operations of, for example, any of blocks 622, 624, 642, 644, 646, 648, 662, 664, 666, and 668 of methods 620, 640, and 660, as described.

In block 814, the processing system may use an SCMI framework or other inter-process or inter-processor communications mechanism or protocol to securely communicate information between the request component included in the kernel portion of the computing system and the configure component included in the secure software portion of the computing system. In some embodiments, in block 814, the processing system may perform the operations of any of blocks 646, 648, 666, and 668 as described.

In block 804, the processing system may perform the operations of the like-numbered blocks of method 800 as described.

With reference to FIGS. 1-8C, in block 602 of method 820 (FIG. 8C), the processing system may perform the operations of the like-numbered blocks of methods 600, 800, and 810 as described.

In block 812, the processing system may perform the operations of the like-numbered blocks of method 810 as described.

In block 824, the processing system may use a SCMI framework to send an MPAM configuration request message to the configure component included in the secure software portion and operating on a CPUCP. For example, the processing system may generate commands based on the current and predicted future workload requirements or resource availability and encode the generated commands into a format compatible with the SCMI framework. The configure component within the secure software may receive and analyze the commands to make real-time adjustments to the cache allocations or other memory management parameters. In some embodiments, the configure component may use the dedicated processing capabilities of the CPUCP to make the adjustments.

In block 826, the processing system may partition (e.g., via the CPUCP) cache memory for use by multiple software applications operating on the computing system based on specific requirements or priority levels of each of the software applications. In some embodiments, the processing system may partition the cache memory to reduce cache collisions, cache pollution, or cache thrashing based on MPAM configurations or QoS parameters associated with a component that is not configured to support MPAM operations. In some embodiments, the processing system may partition the cache memory so that one cache memory portion is reserved for secure applications and the remaining cache memory portions are reserved for non-secure applications.

In block 804, the processing system may perform the operations of the like-numbered block of method 800 as described.

With reference to FIGS. 1-8D, in block 602 of method 830 (FIG. 8D), the processing system may perform the operations of the like-numbered blocks of methods 600, 800, 810, 820 as described.

In block 804, the processing system may perform the operations of the like-numbered blocks of method 800 as described. In the example illustrated in FIG. 8D, the operations of block 804 include the operations blocks 622, 642, 662 of methods 620, 640, and 660 as described. The operations of block 804 may include any or all of the operations discussed with reference blocks 832-846.

In response to determining that the operating mode is KERNEL_FULL_CONTROL mode in block 622, the processing system may cause or allow the kernel to assume control over the MPAM configurations for each memory segment or software application in block 832. As discussed, this control may allow the kernel to manage memory resources directly. The kernel may, for example, dynamically adjust memory segments based on application performance metrics or system conditions and/or prioritize memory allocations for high-demand applications.

In block 834, the processing system may cause or allow the CPUCP to implement the kernel's commands without modification. As discussed, these operations may allow the kernel to retain primary control and use the CPUCP to efficiently execute configurations or allocation strategies.

In response to determining that the operating mode is SECURE_SW_FULL_CONTROL mode in block 642, the processing system may cause or allow the kernel to operate as a pass-through component that forwards received information to the CPUCP in block 836. As discussed, in some embodiments, these operations may include synchronizing operations between the kernel and the CPUCP to improve or maintain security, performance, efficiency, etc.

In block 838, the processing system may cause or allow the CPUCP to assume complete control over the MPAM configurations for each memory segment or software application. As discussed, the processing system may grant the CPUCP the autonomy to manage critical memory resources and perform additional operations to maintain system integrity, prevent resource conflicts, etc.

In response to determining that the operating mode is HYBRID mode in block 662, the processing system may cause or allow the kernel and the CPUCP to share control over the MPAM configurations for each memory segment or software application in block 840. As discussed, this shared control may improve the performance and functioning of the computing system.

In block 842, the processing system may cause or allow the kernel to issue commands proposing specific performance configurations, such as a CPU Performance Configuration or a System Performance Configuration. These operations may allow the kernel to dynamically adapt to changing conditions.

In block 844, the processing system may cause or allow the CPUCP to dynamically adjust the commands based on workload data, real-time system parameters, or additional system information (e.g., data regarding current resource utilization on the computing system, network traffic, current operations, hardware-specific data, etc.). For example, as discussed, these operations may allow the computing system to implement dynamic resource management strategies that improve computational efficiency and system responsiveness.

In block 846, the processing system may allocate memory segments to software applications represented by different PARTIDs. For example, the processing system may distribute memory resources among applications based on current or predicted future resource requirements.

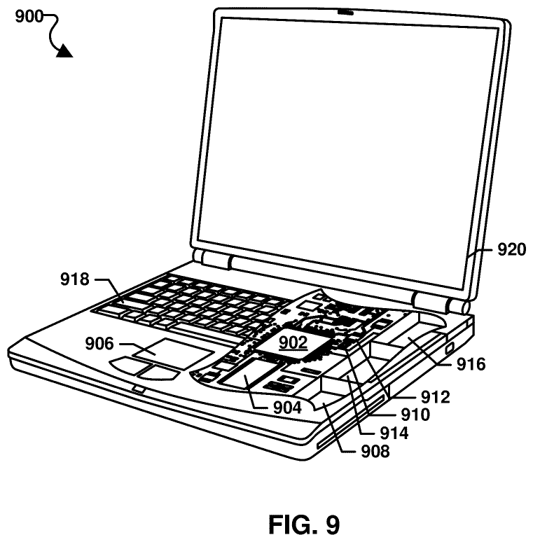

Various embodiments (including, but not limited to, embodiments described above with reference to FIGS. 1-9) may be implemented in a wide variety of computing systems, including a laptop computer 900, an example of which is illustrated in FIG. 9. With reference to FIGS. 1-9, a laptop computer may include a processor 902 coupled to volatile memory 904 and a large capacity nonvolatile memory, such as a disk drive 906 of Flash memory. The laptop computer 900 may include a touchpad touch surface 908 that serves as the computer's pointing device and thus may receive drag, scroll, and flick gestures. Additionally, the laptop computer 900 may have one or more antenna 910 for sending and receiving electromagnetic radiation that may be connected to a wireless data link and/or cellular telephone transceiver 912 coupled to the processor 902. The laptop computer 900 may also include a BT transceiver 914, a compact disc (CD) drive 916, a keyboard 918, and a display 920 all coupled to the processor 902. Other configurations of computing system may include a computer mouse or trackball coupled to the processor (e.g., via a Universal Serial Bus (USB) input) as are well known, which may also be used in conjunction with various embodiments.

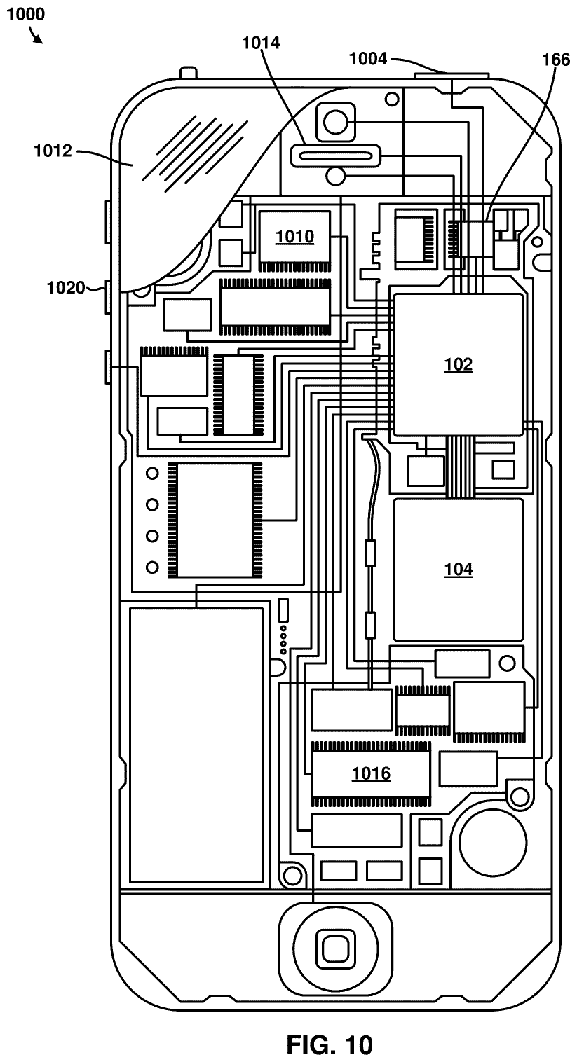

FIG. 10 is a component block diagram of another example of a computing system suitable for use with various embodiments. With reference to FIGS. 1-10, various embodiments may be implemented on a variety of computing systems, an example of which is illustrated in FIG. 10 in the form of a smartphone 1000. The smartphone 1000 may include a first SOC 102 coupled to a second SOC 104. The first and second SoCs 102, 104 may be coupled to internal memory 1016, a display 1012, and a speaker 1014. The first and second SOCs 102, 104 may also be coupled to at least one subscriber identity module (SIM) 1040 and/or a SIM interface that may store information supporting a first 5GNR subscription and a second 5GNR subscription, which support service on a 5G non-standalone (NSA) network.

The smartphone 1000 may include an antenna 1004 for sending and receiving electromagnetic radiation that may be connected to a wireless transceiver 166 coupled to one or more processors in the first and/or second SOCs 102, 104. The smartphone 1000 may also include menu selection buttons or rocker switches 1020 for receiving user inputs.

The smartphone 1000 also includes a sound encoding/decoding (CODEC) circuit 1010, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166, and CODEC 1010 may include a digital signal processor (DSP) circuit (not shown separately).

The processors or processing units discussed in this application may be any programmable microprocessor, microcomputer, or multiple processor chip or chips that can be configured by software instructions (applications) to perform a variety of functions, including the functions of various embodiments described. In some computing systems, multiple processors may be provided, such as one processor within the first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing system including a processor configured (e.g., with processor-executable instructions) to perform operations of the methods of the following implementation examples; the example methods discussed in the following paragraphs implemented by a computing system including means for performing functions of the methods of the following implementation examples; and the example methods discussed in the following paragraphs may be implemented as a non-transitory processor-readable storage medium having stored thereon processor-executable instructions configured to cause a processor of a computing system to perform the operations of the methods of the following implementation examples.

Example 1. A method of allocating memory resources in a computing system by centralizing MPAM operations, the method including: determining an operating mode of the computing system; and allocating memory segments to software applications represented by different PARTIDs that are operating on the computing system based on the determined operating mode.

Example 2. The method of example 1, further including: dividing the MPAM operations between a request component included in a kernel portion of the computing system and a configure component included in a secure software portion of the computing system; and using a SCMI framework or other IPC mechanism or protocols of the computing to securely communicate information between the request component included in the kernel portion of the computing system and the configure component included in the secure software portion of the computing system.

Example 3. The method of either of examples 1 or 2, wherein using the SCMI framework of the computing to securely communicate information between the request component included in the kernel portion of the computing system and the configure component included in the secure software portion of the computing system comprises: using the SCMI framework to communicate information between a central processing unit (CPU) core in the computing system and a CPUCP in the computing system.

Example 4. The method of any of examples 1-3, wherein using the SCMI framework to communicate information between the CPU core in the computing system and the CPUCP in the computing system comprises: using the SCMI framework to send an MPAM configuration request message to the configure component included in the secure software portion and operating on the CPUCP.

Example 5. The method of any of examples 1-4, further including partitioning, by the CPUCP, the cache memory for use by multiple software applications operating on the computing system based on specific requirements or priority levels of each of the software applications.

Example 6. The method of any of examples 1-5, wherein partitioning, by the CPUCP, the cache memory for use by multiple software applications operating on the computing system based on the specific requirements or priority levels of each of the software applications comprises: partitioning, by the CPUCP, the cache memory based on MPAM configurations and/or QoS parameters to reduce cache collisions, cache pollution, or cache thrashing.

Example 7. The method of any of examples 1-6, wherein the QoS parameters are associated with a component that is not configured to support MPAM operations.

Example 8. The method of e of any of examples 1-5, wherein partitioning, by the CPUCP, the cache memory for use by multiple software applications operating on the computing system based on the specific requirements or priority levels of each of the software applications comprises: partitioning, by the CPUCP, the cache memory that one cache memory portion is reserved for secure applications and the remaining cache memory portions are reserved for non-secure applications.

Example 9. The method of any of examples 1-8, wherein: the kernel assumes complete control over the MPAM configurations for each memory segment or software application and the CPUCP implements the kernel's commands without modification while the computing system operates in a KERNEL_FULL_CONTROL mode; the kernel operates as a pass-through component by forwarding received information to the CPUCP and the CPUCP assumes complete control over the MPAM configurations for each memory segment or software application while the computing system operates in a SECURE_SW_FULL_CONTROL mode; and the kernel and the CPUCP share control over the MPAM configurations for each memory segment or software application while the computing system operates in a HYBRID mode.

Example 10. The method of any of examples 1-9, wherein: the computing system operates in the HYBRID mode; the kernel issues commands proposing specific performance configurations, such as a CPU Performance Configuration (CPU_PERF_CONFIG) or a System Performance Configuration (SYSTEM_PERF_CONFIG); and the CPUCP dynamically adjusts the commands to adjust the MPAM configurations based on workload data, real-time system parameters, or additional system information such as data regarding a current resource utilization on the computing system, network traffic, current operations (e.g., data reading, writing, processing tasks, etc.), or hardware-specific data (e.g., thermal sensor readings, the current status of CPU cores, etc.).

Example 11. The method of any of examples 1-10, wherein the operations for allocating memory segments to software applications represented by different PARTIDs that are operating on the computing system are performed in a virtual machine (VM) configured to allow for autonomous or hybrid mode configuration of MPAM.

Example 12. A method of allocating memory resources in a computing system, the method including: receiving, by a CPUCP of the computing system, a kernel request for a MPAM configuration in a secure software portion of the computing system; and configuring, by the CPUCP, one or more MPAM registers in the computing system based on the received kernel request.

Example 13. The method of example 12, wherein configuring the one or more MPAM registers in the computing system based on the received kernel request comprises coordinating, by the CPUCP, the MPAM configurations across multiple security states or between secure and non-secure operations.

Example 14. The method of either of examples 12 or 13, further including selecting one of a plurality of operation modes including: a KERNEL_FULL_CONTROL mode; a SECURE/CPUCP_SW_FULL_CONTROL mode, or a HYBRID_MODE.

Example 15. The method of any of examples 12-14, wherein configuring the one or more MPAM registers in the computing system based on the received kernel request comprises utilizing various system parameters including thermal parameters, core-count parameters, effective frequency parameters, and DDR parameters to allocate cache through MPAM and configure additional Quality of Service (QOS) parameters.

Example 16. The method of any of examples 12-15, wherein configuring the one or more MPAM registers in the computing system based on the received kernel request comprises configuring the one or more MPAM registers using virtual machines (VMs) and the secure software's autonomous or hybrid mode.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing system and the computing system or computing device may be referred to as a component. One or more components may reside within a process and/or thread of execution and a component may be localized on one processor or core and/or distributed between two or more processors or cores. In addition, these components may execute from various non-transitory computer-readable media having various instructions and/or data structures stored thereon. Components may communicate by way of local and/or remote processes, function or procedure calls, electronic signals, data packets, memory read/writes, and other known network, computer, processor, and/or process-related communication methodologies.

A number of different types of memories and memory technologies are available or contemplated in the future, any or all of which may be included and used in systems and computing systems that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudo-static random-access memory (PSRAM). Computing systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in or by a vehicle's advanced driver assistance system (ADAS), SOC or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or another programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of programmable devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disc, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of allocating memory resources in a computing system by centralizing memory-system resource partitioning and monitoring (MPAM) operations, the method comprising:
determining an operating mode of the computing system; and
allocating memory segments to software applications represented by different partition identifiers (PARTIDs) that are operating on the computing system based on the determined operating mode.

2. The method of claim 1, further comprising:
dividing the MPAM operations between a request component included in a kernel portion of the computing system and a configure component included in a secure software portion of the computing system; and
using a system control and management interface (SCMI) framework or other inter-processor communications mechanism or protocol of the computing to securely communicate information between the request component included in the kernel portion of the computing system and the configure component included in the secure software portion of the computing system.

3. The method of claim 1, further comprising:
dividing the MPAM operations between a request component included in a kernel portion of the computing system and a configure component included in a secure software portion of the computing system; and
using a system control and management interface (SCMI) framework to send an MPAM configuration request message to the configure component included in the secure software portion and operating on a central processing unit (CPU) co-processor (CPUCP) of the computing system.

4. The method of claim 3, further comprising:
partitioning, by the CPUCP, cache memory for use by multiple software applications operating on the computing system based on specific requirements or priority levels of each of the software applications.

5. The method of claim 4, wherein partitioning, by the CPUCP, the cache memory for use by multiple software applications operating on the computing system based on the specific requirements or priority levels of each of the software applications comprises:
partitioning, by the CPUCP, the cache memory to reduce cache collisions, cache pollution, or cache thrashing based on MPAM configurations or quality of service (QOS) parameters associated with a component that is not configured to support MPAM operations.

6. The method of claim 4, wherein partitioning, by the CPUCP, the cache memory for use by multiple software applications operating on the computing system based on the specific requirements or priority levels of each of the software applications comprises:
partitioning, by the CPUCP, the cache memory so that one cache memory portion is reserved for secure applications, and the remaining cache memory portions are reserved for non-secure applications.

7. The method of claim 1, wherein:
a kernel portion of the computing system assumes complete control over the MPAM configurations for each memory segment or software application and a central processing unit (CPU) co-processor (CPUCP) of the computing system implements the kernel's commands without modification while the computing system operates in a KERNEL_FULL_CONTROL mode;
the kernel operates as a pass-through component by forwarding received information to the CPUCP and the CPUCP assumes complete control over the MPAM configurations for each memory segment or software application while the computing system operates in a SECURE_SW_FULL_CONTROL mode; and
the kernel and the CPUCP share control over the MPAM configurations for each memory segment or software application while the computing system operates in a HYBRID mode.

8. The method of claim 7, wherein:
the computing system operates in the HYBRID mode;
the kernel issues commands proposing specific performance configurations, such as a CPU Performance Configuration or a System Performance Configuration; and
the CPUCP dynamically adjusts the commands to adjust the MPAM configurations based on workload data, real-time system parameters, or additional system information comprising data regarding a current resource utilization on the computing system, network traffic, current operations, or hardware-specific data.

9. The method of claim 1, wherein the operations for allocating memory segments to software applications represented by PARTIDs that are operating on the computing system are performed in a virtual machine configured to allow for autonomous or hybrid mode configuration of MPAM operations.

10. A computing system, comprising:
a memory; and
a central processing unit (CPU) co-processor (CPUCP) coupled to the memory, wherein the CPUCP is configured to:
determine an operating mode of the computing system; and
allocate memory segments to software applications represented by different partition identifiers (PARTIDs) that are operating on the computing system based on the determined operating mode.

11. The computing system of claim 10, wherein the CPUCP is further configured to:
divide memory-system resource partitioning and monitoring (MPAM) operations between a request component included in a kernel portion of the computing system and a configure component included in a secure software portion of the computing system; and
use a system control and management interface (SCMI) framework to send an MPAM configuration request message to the configure component included in the secure software portion and operating on the CPUCP.

12. The computing system of claim 11, wherein the CPUCP is further configured to:
partition cache memory for use by multiple software applications operating on the computing system based on specific requirements or priority levels of each of the software applications.

13. The computing system of claim 11, wherein the CPUCP is further configured to:
partition cache memory so that one cache memory portion is reserved for secure applications, and the remaining cache memory portions are reserved for non-secure applications.

14. The computing system of claim 10, wherein:
a kernel portion of the computing system assumes complete control over the MPAM configurations for each memory segment or software application and the CPUCP implements the kernel's commands without modification while the computing system operates in a KERNEL_FULL_CONTROL mode;
the kernel operates as a pass-through component by forwarding received information to the CPUCP and the CPUCP assumes complete control over the MPAM configurations for each memory segment or software application while the computing system operates in the SECURE_SW_FULL_CONTROL mode; and
the kernel and the CPUCP share control over the MPAM configurations for each memory segment or software application while the computing system operates in a HYBRID mode.

15. The computing system of claim 14, wherein:
the computing system operates in the HYBRID mode;
the kernel issues commands proposing specific performance configurations comprising a CPU Performance Configuration or a System Performance Configuration; and
the CPUCP dynamically adjusts the commands to adjust the MPAM configurations based on workload data, real-time system parameters, or data regarding a current resource utilization on the computing system, network traffic, current operations, or hardware-specific data.

16. A method of allocating memory resources in a computing system, the method comprising:
receiving, by a CPU co-processor (CPUCP) of the computing system, a kernel request for a memory-system resource partitioning and monitoring (MPAM) configuration in a secure software portion of the computing system; and
configuring, by the CPUCP, one or more MPAM registers in the computing system based on the received kernel request.

17. The method of claim 16, wherein configuring the one or more MPAM registers in the computing system based on the received kernel request comprises coordinating, by the CPUCP, the MPAM configurations across multiple security states or between secure and non-secure operations.

18. The method of claim 16, further comprising selecting one of a plurality of operation modes comprising:
a KERNEL_FULL_CONTROL mode;
a SECURE/CPUCP_SW_FULL_CONTROL mode, or
a HYBRID_MODE.

19. The method of claim 16, wherein configuring the one or more MPAM registers in the computing system based on the received kernel request comprises utilizing system parameters including thermal parameters, core-count parameters, effective frequency parameters, and DDR parameters to allocate cache through MPAM and configure additional Quality of Service (QOS) parameters.

20. A computing system, comprising:
a memory;
one or more memory-system resource partitioning and monitoring (MPAM) registers; and
a central processing unit (CPU) co-processor (CPUCP) coupled to the memory and the one or more MPAM registers, wherein the CPUCP is configured to:
receive a kernel request for a memory-system resource partitioning and monitoring (MPAM) configuration in a secure software portion of the computing system;
configure the one or more MPAM registers in the computing system based on the received kernel request including coordinating the MPAM configurations across multiple security states or between secure and non-secure operations; and
selecting one of a plurality of operation modes comprising:
a KERNEL_FULL_CONTROL mode;
a SECURE/CPUCP_SW_FULL_CONTROL mode, or
a HYBRID_MODE.
